(19) United States
(12) Patent Application Publication
(10) Pub. No.: US 2025/0145227 A1
(43) Pub. Date: May 8, 2025

(54) Cover Panel for Charging Port and Telescoping Airfoil

(71) Applicant: Karma Automotive LLC, Irvine, CA (US)

(72) Inventor: Nicholas David, Irvine, CA (US)

(73) Assignee: Karma Automotive LLC, Irvine, CA (US)

(21) Appl. No.: 18/932,572

(22) Filed: Oct. 30, 2024

Related U.S. Application Data
(60) Provisional application No. 63/596,809, filed on Nov. 7, 2023.

(51) Int. Cl. B62D 35/00

(52) U.S. Cl. CPC B62D 35/007

(57) ABSTRACT

A method includes, while a vehicle travels in a forward direction, adjusting an airfoil of the vehicle to move between a retracted position and a first extended position. At least a portion of the airfoil is recessed into a rear portion of the vehicle when the airfoil is in the retracted position. The airfoil is extended away from the rear portion of the vehicle when the airfoil is in the first extended position.

### CROSS-REFERENCE TO RELATED APPLICATIONS

This U.S. patent application claims priority under 35 U.S.C. § 119(e) to U.S. Provisional Application 63/596,809, filed on Nov. 7, 2023. The disclosure of this prior application is considered part of the disclosure of this application and is hereby incorporated by reference in its entirety.

### TECHNICAL FIELD

This disclosure is directed to a cover panel for a charging port and telescoping airfoil.

### BACKGROUND

It is known to cover or conceal a fuel port of a vehicle or a charging port of an electric vehicle with a flap or door that is pivotable relative to the port between a closed position, where the flap is disposed over the port to cover and conceal the port, and an opened position, where the flap is pivoted away from the port to expose the port for receiving a fuel source or electrical connector of a charging station. Commonly, the flap is located at the side of the vehicle and is manually pivotable between the closed and opened positions.

### SUMMARY

One aspect of the disclosure provides a computer-implemented method that when executed on data processing hardware causes the data processing hardware to perform operations. While a vehicle is traveling in a forward directions, the operations include adjusting an airfoil of the vehicle to move between a retracted position and a first extended position. When the airfoil is in the retracted position, at least a portion of the airfoil is recessed into a rear portion of the vehicle. When the airfoil is in the first extended position, the airfoil is extended away from the rear portion of the vehicle.

Implementations of the disclosure may include one or more of the following optional features. In some implementations, while the vehicle travels in the forward direction and the airfoil is in the first extended position, the operations also include adjusting the airfoil to move between the first extended position and a second extended position, wherein, when the airfoil is in the second extended position, at least a portion of the airfoil is extended away from the rear portion of the vehicle and wing portions of the airfoil are extended laterally from respective sides of a central portion of the airfoil. In some examples, the operations also include adjusting a pitch of the airfoil when the airfoil is in the first extended position. Here, adjusting the pitch of the airfoil may be based on a speed of the vehicle or operation of a brake system of the vehicle.

In some implementations, when the airfoil is in the retracted position, the operations also include receiving a speed of the vehicle while the vehicle travels in the forward direction; determining the speed of the vehicle satisfies a threshold speed; and based on determining the speed of the vehicle satisfies the threshold speed, adjusting the airfoil to move from the retracted position to the first extended position. In these implementations, after adjusting the airfoil to move from the retracted position to the first extended position, the operations may further include determining the speed of the vehicle dissatisfies the threshold speed and based on determining that the speed of the vehicle dissatisfies the threshold speed, adjusting the airfoil to move from the first extended position to the retracted position.

In some examples, the operations also include receiving a user input. Here, adjusting the airfoil to move between the retracted position and the first extended position is based on the user input. In some additional examples, while the vehicle is stationary and the airfoil is in the retracted position, the operations further include adjusting the airfoil of the vehicle to move from the retracted position into a charging position, Here, when the airfoil is in the charging position, the airfoil is extended away from the rear portion of the vehicle and pitched upward to allow access to a charge port of the vehicle, the charge port disposed in a recess at the rear portion of the vehicle. When the airfoil is in the retracted position, the airfoil may over and along the recess to conceal the charge port from an exterior of the vehicle. Moreover, while the vehicle is stationary and the airfoil is in the retracted position, the operations may further include receiving a user input indicating selection of an actuatable input. Here, the actuatable input may be accessible exterior the vehicle and disposed at or near the rear portion of the vehicle such that adjusting the airfoil of the vehicle to move into the charging position may be based on the received user input indicating selection of the actuatable input. The actuatable input is disposed at an exterior side of a rear window of the vehicle, at a body panel of the vehicle at or near the rear portion of the vehicle, or at an exterior surface of the airfoil.

Another aspect of the present disclosure provides a vehicle including data processing hardware and memory hardware in communication with the data processing hardware. The memory hardware stores instructions that when executed on the data processing hardware causes the data processing hardware to perform operations that include, while the vehicle is traveling in a forward directions, adjusting an airfoil of the vehicle to move between a retracted position and a first extended position. When the airfoil is in the retracted position, at least a portion of the airfoil is recessed into a rear portion of the vehicle. When the airfoil is in the first extended position, the airfoil is extended away from the rear portion of the vehicle.

This aspect of the disclosure may include one or more of the following optional features. In some implementations, while the vehicle travels in the forward direction and the airfoil is in the first extended position, the operations also include adjusting the airfoil to move between the first extended position and a second extended position, wherein, when the airfoil is in the second extended position, at least a portion of the airfoil is extended away from the rear portion of the vehicle and wing portions of the airfoil are extended laterally from respective sides of a central portion of the airfoil. In some examples, the operations also include adjusting a pitch of the airfoil when the airfoil is in the first extended position. Here, adjusting the pitch of the airfoil may be based on a speed of the vehicle or operation of a brake system of the vehicle.

In some implementations, when the airfoil is in the retracted position, the operations also include receiving a speed of the vehicle while the vehicle travels in the forward direction; determining the speed of the vehicle satisfies a threshold speed; and based on determining the speed of the vehicle satisfies the threshold speed, adjusting the airfoil to move from the retracted position to the first extended position. In these implementations, after adjusting the airfoil to move from the retracted position to the first extended position, the operations may further include determining the speed of the vehicle dissatisfies the threshold speed and based on determining that the speed of the vehicle dissatisfies the threshold speed, adjusting the airfoil to move from the first extended position to the retracted position.

In some examples, the operations also include receiving a user input. Here, adjusting the airfoil to move between the retracted position and the first extended position is based on the user input. In some additional examples, while the vehicle is stationary and the airfoil is in the retracted position, the operations further include adjusting the airfoil of the vehicle to move from the retracted position into a charging position, Here, when the airfoil is in the charging position, the airfoil is extended away from the rear portion of the vehicle and pitched upward to allow access to a charge port of the vehicle, the charge port disposed in a recess at the rear portion of the vehicle. When the airfoil is in the retracted position, the airfoil may over and along the recess to conceal the charge port from an exterior of the vehicle. Moreover, while the vehicle is stationary and the airfoil is in the retracted position, the operations may further include receiving a user input indicating selection of an actuatable input. Here, the actuatable input may be accessible exterior the vehicle and disposed at or near the rear portion of the vehicle such that adjusting the airfoil of the vehicle to move into the charging position may be based on the received user input indicating selection of the actuatable input. The actuatable input is disposed at an exterior side of a rear window of the vehicle, at a body panel of the vehicle at or near the rear portion of the vehicle, or at an exterior surface of the airfoil.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a side perspective view of a vehicle with a telescoping and adjustable retractable airfoil that provides a cover panel for a charge port of the vehicle.

FIGS. 2A-2F are views of the vehicle of FIG. 1 with the airfoil in a charging position, where the airfoil is extended from the rear portion of the vehicle and tilted to provide access to an electrical connector positioned within a recess below the airfoil.

FIGS. 3A-3F are views of the vehicle of FIG. 1 with the airfoil in a first driving position.

FIGS. 4A-4H are views of the vehicle with the airfoil in a second driving position with telescoping wings extending laterally from the airfoil.

FIG. 5 is a flowchart of an exemplary method of controlling operation of the airfoil.

Like reference symbols in the various drawings indicate like elements.

### DETAILED DESCRIPTION

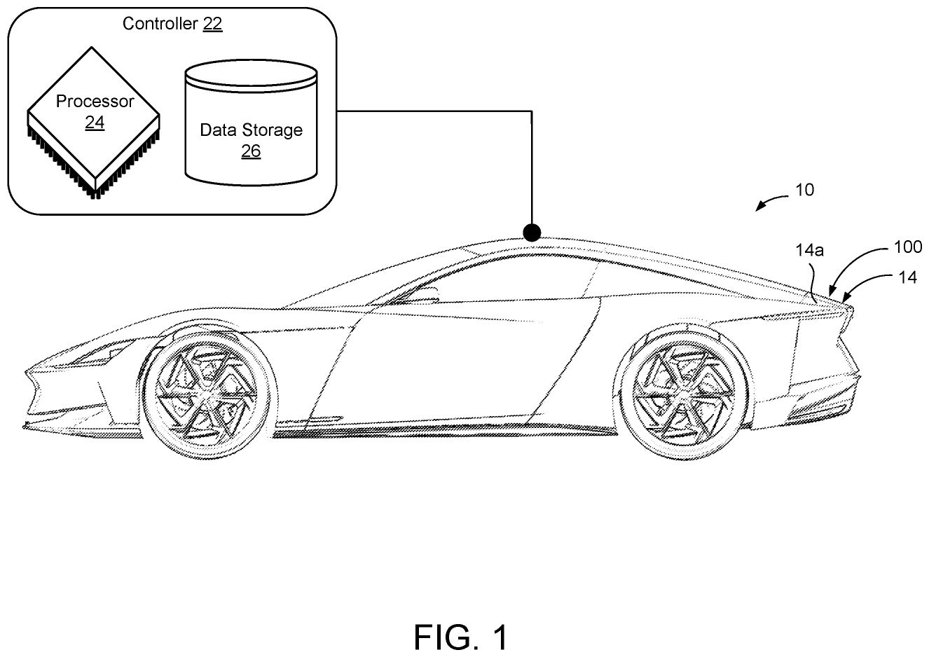

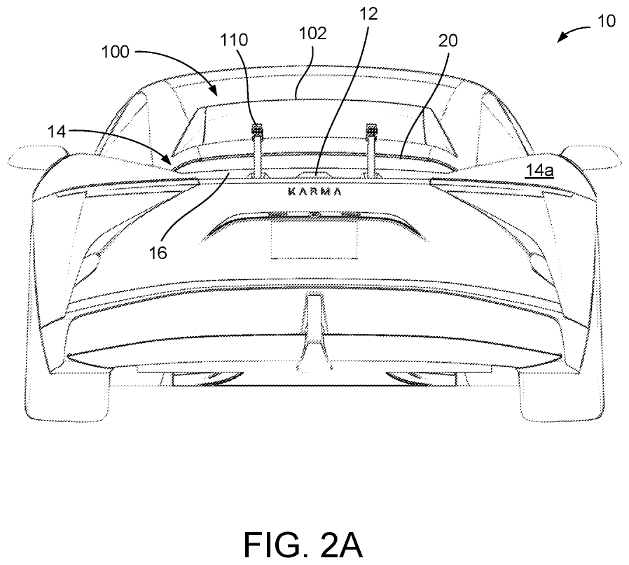

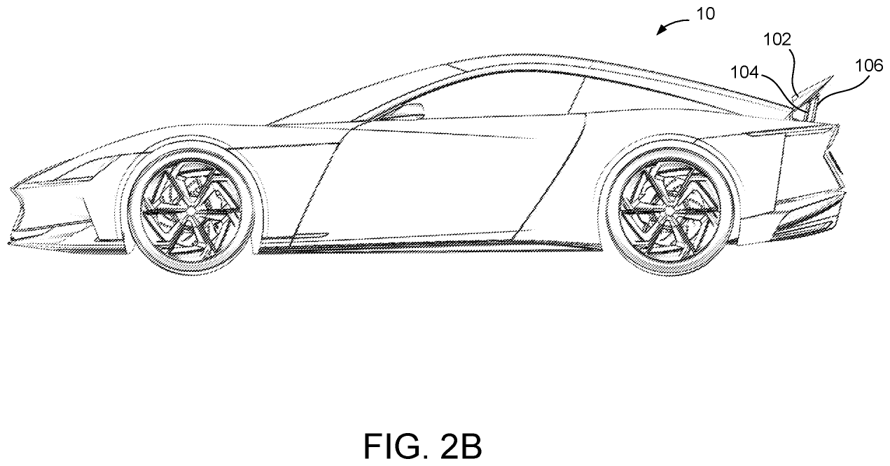

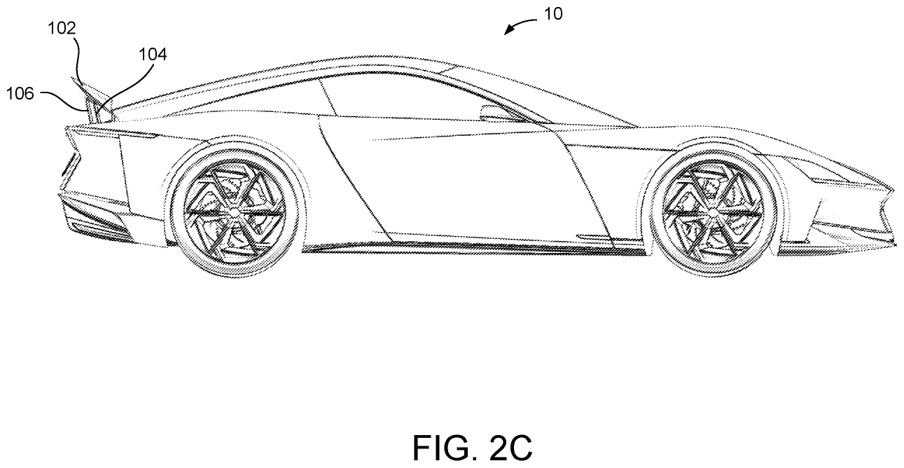

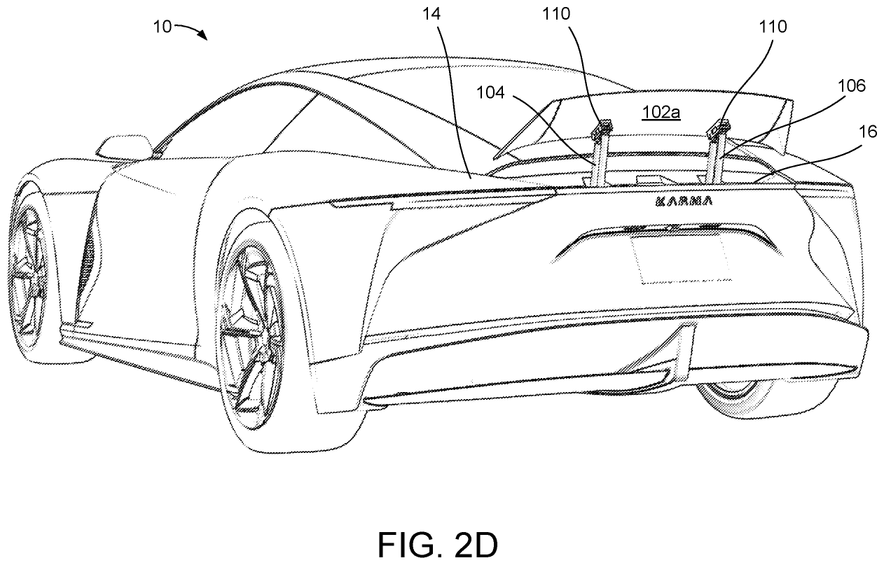

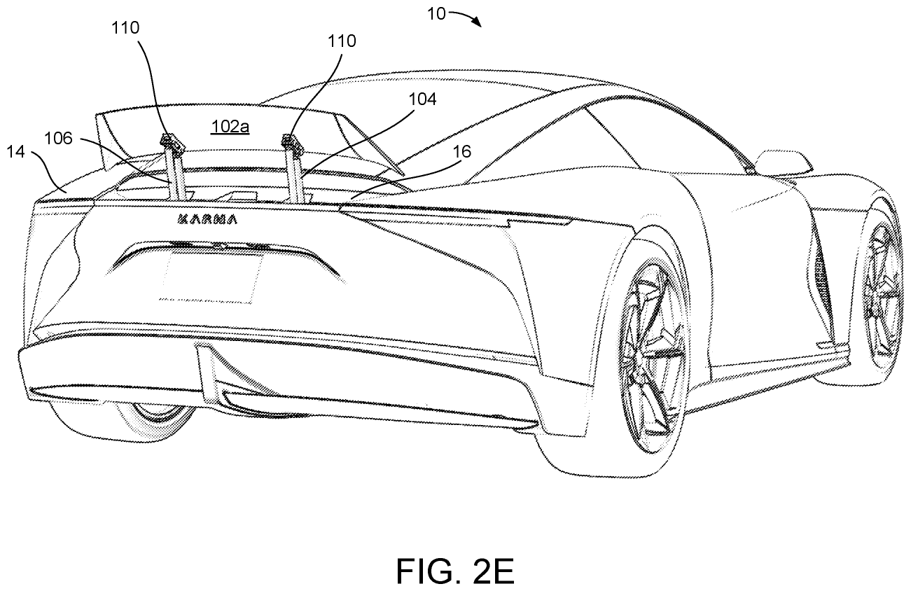

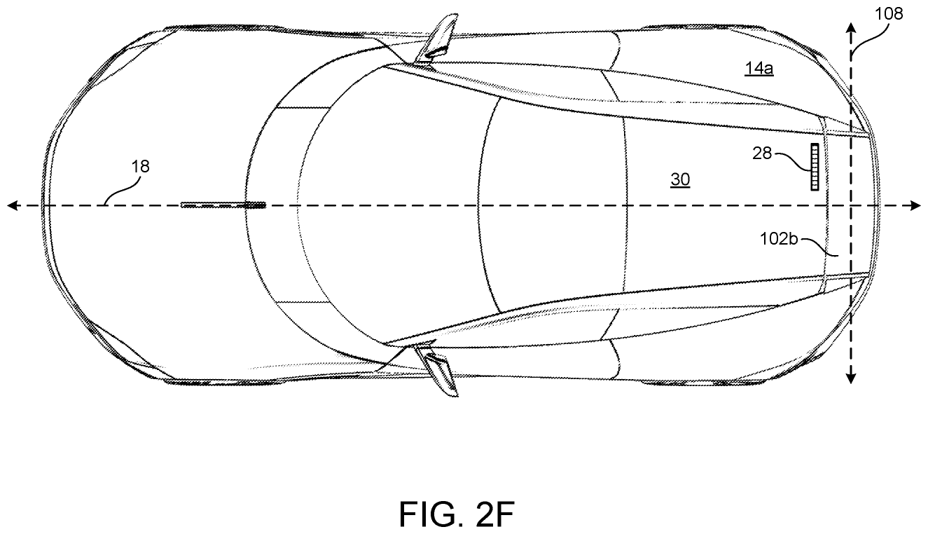

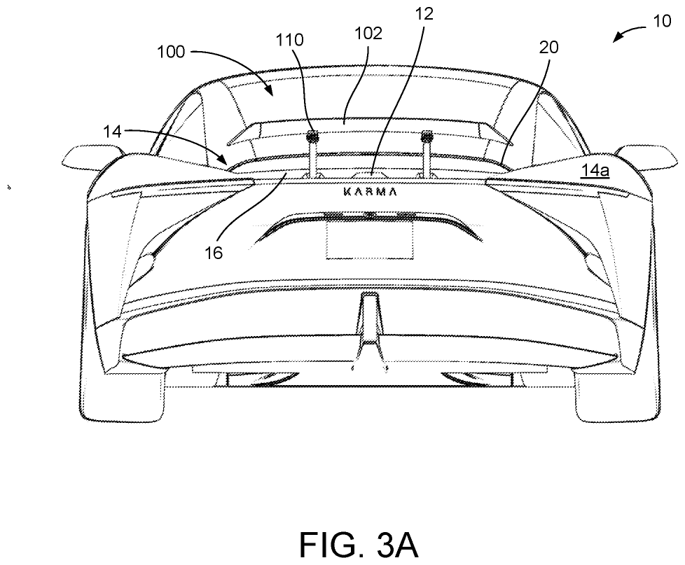

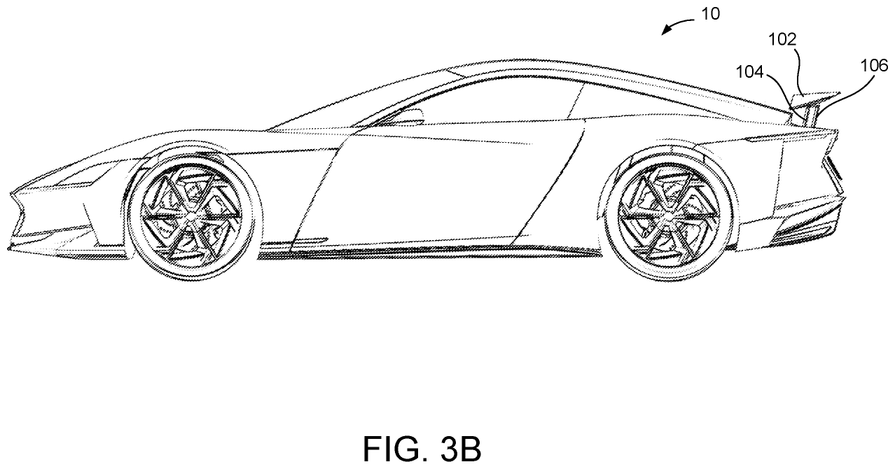

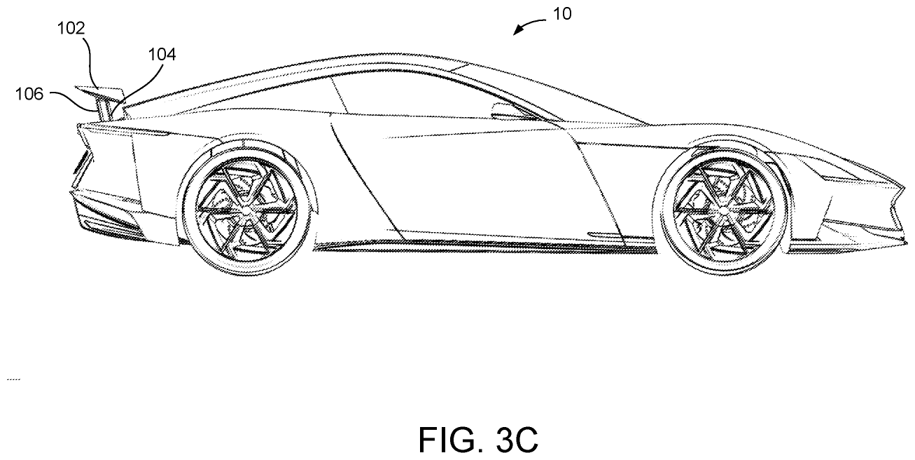

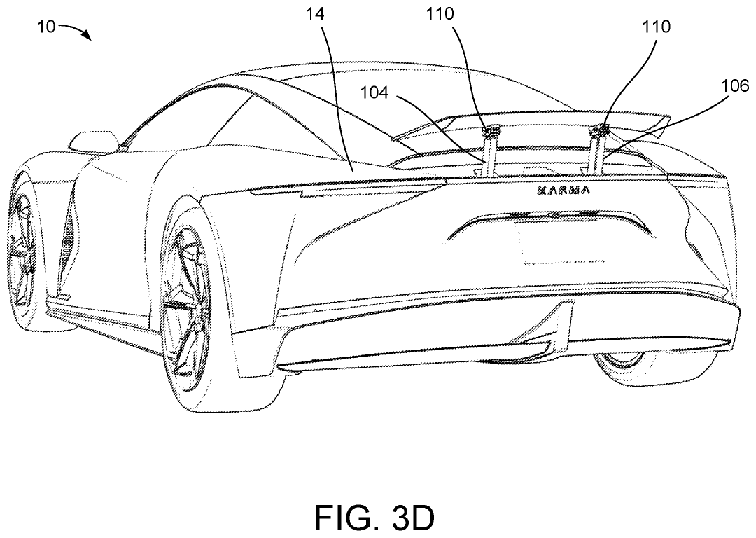

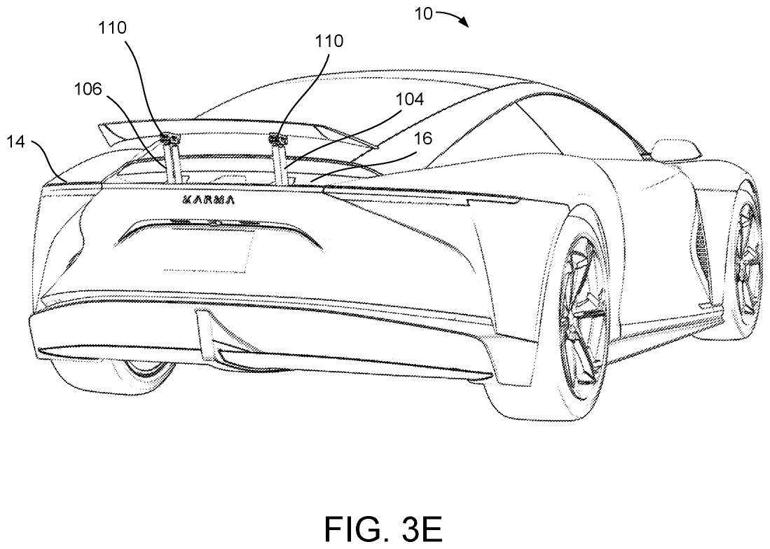

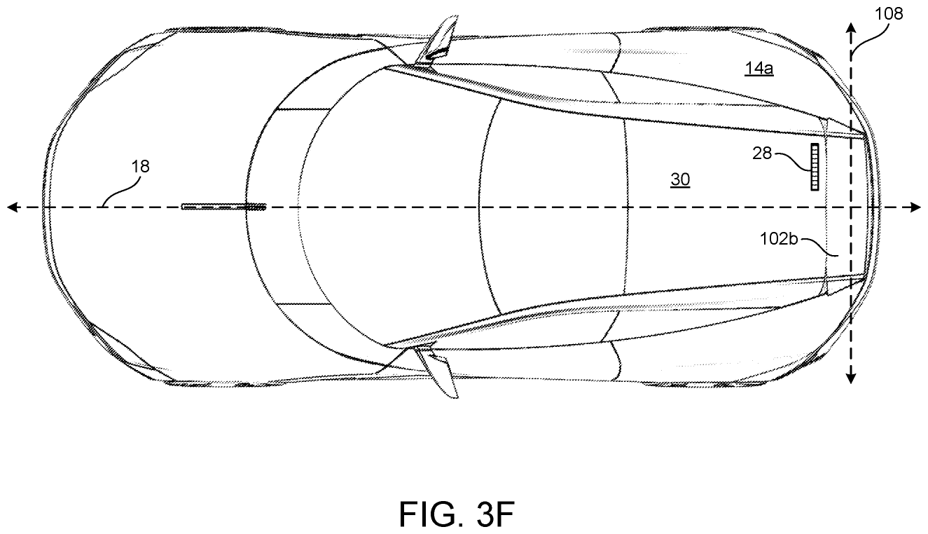

Referring to FIGS. 1-4H, a vehicle 10, such as a battery electric vehicle (BEV) or a plug-in hybrid vehicle (PHEV), includes a charge port 12 configured to electrically connect with an electrical connector of a charging wand to charge energy storage devices (e.g., batteries) of the vehicle 10. The charge port 12 is disposed at a rear portion 14 of the vehicle 10, such as at or near a rear liftgate or rear bumper of the vehicle 10. In the illustrated example, the charge port 12 is disposed within a recess or cavity 16 at the rear portion 14 of the vehicle 10. As discussed further below, a retractable airfoil system 100 is disposed at or near the rear portion 14 of the vehicle 10 and includes an airfoil 102 that, in a closed or retracted position (FIG. 1), is at least partially recessed into the rear portion 14 of the vehicle 10 and extends over and along the recess 16 to conceal the charge port 12. The airfoil 102 is movable from the retracted position to a charging position (FIGS. 2A-2F), where the airfoil 102 is extended at least partially away from the rear portion 14 and the recess 16 of the vehicle 10 to allow access to the charge port 12 when charging the batteries of the vehicle 10. Moreover, the airfoil 102 is movable to at least a first extended position or driving position (FIGS. 3A-3F), where the airfoil 102 is extended at least partially away from the rear portion 14 of the vehicle 10 to deflect airflow moving across the airfoil 102 and impart lift and/or downforce at the rear portion 14 of the vehicle 10 as the vehicle 10 travels in a forward direction. Thus, the system 100 provides both a cover panel for the charge port 12 of the vehicle 10 and an active and retractable airfoil 102. Aspects of the system 100 described herein may also be suitable for use with a fuel port cover for covering a fuel filler port or opening of a vehicle that is configured to receive a nozzle that delivers fuel (e.g., gasoline) to a fuel tank of the vehicle via the fuel port.

As shown in FIGS. 2A-2E, 3A-3E, and 4A-4E, the retractable airfoil system 100 includes the airfoil 102 and two pairs of pistons 104, 106 configured to attach the airfoil 102 to the rear portion 14 of the vehicle 10. That is, a set of first or forward pistons 104 and a set of second or rearward pistons 106 that extend from respective proximal ends attached to the rear portion 14 of the vehicle 10 (e.g., from within the cavity 16) to respective proximal ends attached at a bottom or lower or inner surface 102a (FIGS. 2D and 2E) of the airfoil 102. The forward pistons 104 and the rearward pistons 106 are generally parallel to one another, with each of the forward pistons 104 attached to the airfoil 102 at a forward region of the airfoil 102 and each of the rearward pistons 106 attached to the airfoil 102 at a reward region of the vehicle 102. In other words, the forward pistons 104 are attached at the inner surface 102a of the airfoil 102 at a position along a longitudinal axis 18 (FIGS. 2F, 3F, and 4H) of the vehicle 10 that is closer to the front of the vehicle 10 than the attachment position of the rearward pistons 106. A longitudinal axis 108 (FIGS. 2F, 3F, and 4H) of the airfoil 102 may bisect the airfoil 102 between the forward pistons 104 and the rearward pistons 106 to delineate the forward region and the rearward region of the airfoil 102. The longitudinal axis 108 of the airfoil 102 may be substantially perpendicular to the longitudinal axis 118 of the vehicle 10. Left and right or driver-side and passenger-side pistons of the forward pistons 104 and the rearward pistons 106 are spaced from one another along the longitudinal axis 108 of the airfoil 102.

In the illustrated example, the forward pistons 104 and the rearward pistons 106 are pivotally attached at the bottom/inner surface 102a of the airfoil 102 so that the airfoil 102 can be tilted or pitched about the longitudinal axis 108 of the airfoil 102 based on the relative heights of the forward pistons 104 and the rearward pistons 106 from the rear portion 14 of the vehicle 10. For example, the driver-side pistons and the passenger-side pistons are pivotally attached at respective brackets or mounting portions 110 (FIGS. 2D, 2E, 3D, 3E, 4D, and 4E) disposed at the inner surface 102a of the airfoil 102. That is, one forward piston 104 and one rearward piston 106 are both attached at one bracket 110, with the bracket 110 extending along the inner surface 102a of the airfoil 102 and perpendicular to the longitudinal axis 108 of the airfoil 102.

The forward pistons 104 and the rearward pistons 106 are extendable and retractable relative to the rear portion 14 of the vehicle 10 to move the airfoil 102 between positions relative to the charge port 12 and rear portion 14 of the vehicle 10. Further, the forward pistons 104 are extendable and retractable from the rear portion 14 of the vehicle 10 together and in tandem, and the rearward pistons 106 are extendable and retractable from the rear portion 14 of the vehicle together and in tandem, with the front pistons 104 separately extendable and retractable from the rearward pistons 106.

That is, a first drive mechanism may be operable to extend and retract the forward pistons 104 and a second drive mechanism may be operable to extend and retract the rearward pistons 106 separate from operation of the first drive mechanism. For example, the forward pistons 104 and the rearward pistons 106 may be mechanically coupled to separate electrically operated or hydraulic actuators that, when operated, extend and retract the respective forward pistons 104 and rearward pistons 106 relative to the rear portion 14 of the vehicle 10.

In some examples, a first drive mechanism is operable to extend and retract the forward pistons 104 and the rearward pistons 106 together and in tandem and a second drive mechanism is operable to extend and retract the rearward pistons 106 relative to the forward pistons 104. For example, an electrically operable actuator may be operable to extend and retract the forward pistons 104 and the rearward pistons 106 (e.g., to raise and lower the airfoil 102 from the retracted position) and a separate pneumatic or hydraulic actuator may be operable to extend and retract the rearward pistons 106 relative to the forward pistons 104 (e.g., to pitch the airfoil 102 when the airfoil 102 is extended from the rear portion 14 of the vehicle 10).

Thus, extension and retraction of the forward pistons 104 adjusts a height of the forward portion of the airfoil 102 relative to the rear portion 14 of the vehicle 10 and extension and retraction of the rearward pistons 106 adjusts a height of the rearward portion of the airfoil 102 relative to the rear portion 14 of the vehicle. When the forward pistons 104 and the rearward pistons 106 are retracted toward and/or into the rear portion 14 of the vehicle 10, the airfoil 102 is in the retracted position. The forward pistons 104 and the rearward pistons 106 are at least partially extended from the rear portion 14 of the vehicle 10 to move the airfoil 102 to the first extended position. The rearward pistons 106 are further extended relative to the forward pistons 104 to tilt or pitch the airfoil 102 about the longitudinal axis 108 of the airfoil 102 and adjust the airfoil to the charging position.

As shown in FIG. 1, when the airfoil 102 is in the retracted position, the airfoil 102 is at least partially recessed into the rear portion 14 of the vehicle 10 and an outer or upper surface 102b of the airfoil 102 corresponds with and/or is substantially flush with an outer surface 14a of the rear portion 14 at and around the recess 16 accommodating the charge port 12. When the airfoil 102 is in the retracted position, the airfoil 102 may at least partially compress a sealing element or gasket 20 between a lower or interior side or an edge region of the airfoil 102 and the rear portion 14 of the vehicle 10 surrounding the recess 16 to protect the charge port 12 and limit or preclude moisture and contaminants from entering the charge port 12 or recess 16 when the airfoil 102 is retracted. For example, the sealing element 20 may be disposed at the rear portion 14 and circumscribing an opening or edge of the recess 16 to be engaged by the airfoil 102 when the airfoil 102 is in the retracted position. A separate cover or flap may be disposed at the charge port 12 for covering and protecting the charge port 12 when the airfoil 102 is extended from the rear portion 14 and the charge port 12 is exposed.

Referring to FIGS. 2A-2F, when the airfoil 102 is moved to the charging position, the forward pistons 104 and the rearward pistons 106 are extended from the rear portion 14 of the vehicle 10 to extend the airfoil 102 at least partially away from the charge port 12 and the rear portion 14 of the vehicle 10. The rear pistons 106 may be extended to a greater degree than the forward pistons 104 so that the airfoil 102 is pitched about the longitudinal axis 108 of the airfoil 102 upward and away from the charge port 12. For example, the rearward pistons 106 may be extended to or near an end of a range of motion of the rearward pistons 106 to provide the greatest possible angle between the airfoil 102 and the longitudinal axis 18 of the vehicle 10. This provides greater clearance and easier access to the charge port 12 for connecting the charging wand to the charge port 12.

As shown in FIGS. 3A-3F, when the airfoil 102 is moved to the first extended position, the forward pistons 104 and the rearward pistons 106 are extended from the rear portion 14 of the vehicle 10 to extend and raise the airfoil 102 at least partially away from the rear portion 14 of the vehicle 10. The forward pistons 104 and the rearward pistons 106 may be extended to respective degrees so that the top or upper surface 102b of the airfoil 102 is generally perpendicular to a gravitational axis. In other words, the angle of the upper surface 102b of the airfoil 102 relative to the longitudinal axis 18 of the vehicle 10 may be less when the airfoil 102 is in the first extended position as compared to the charging position, i.e., a plane defined by the upper surface 102b of the airfoil 102 is convergent with the longitudinal axis 18 of the vehicle 10 when in the charging position). Put another way, the height difference between the rearward pistons 106 and the forward pistons 104 is less when the airfoil 102 is in the first extended position (e.g., FIG. 3B) as compared to the charging position (e.g., FIG. 2B).

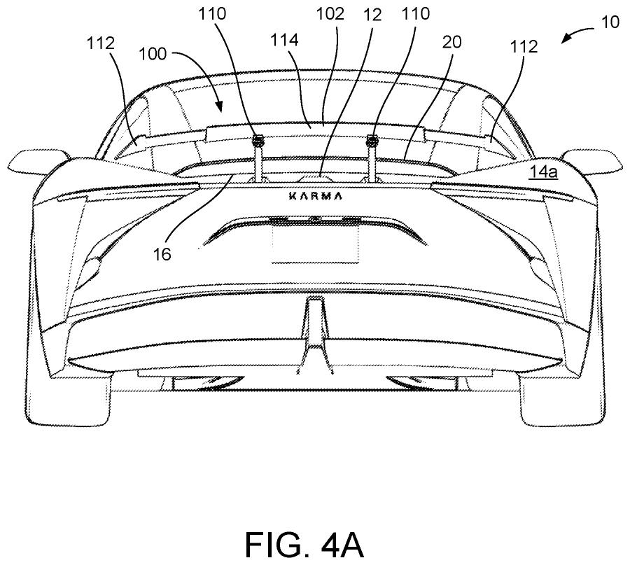

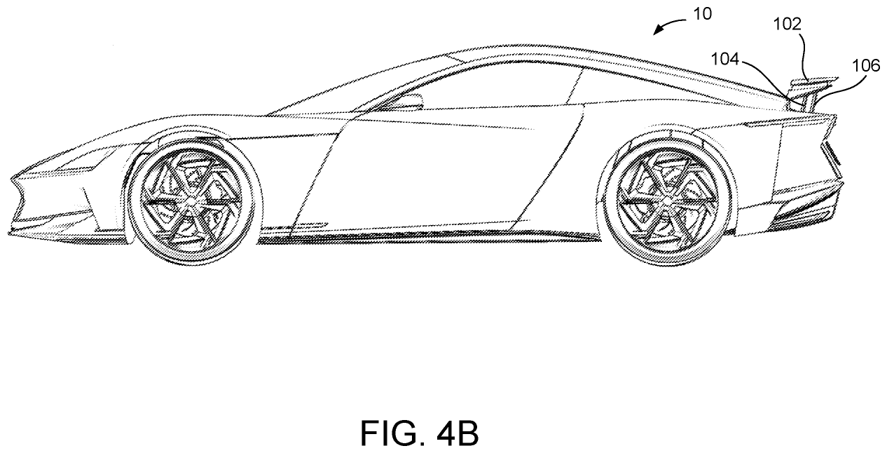

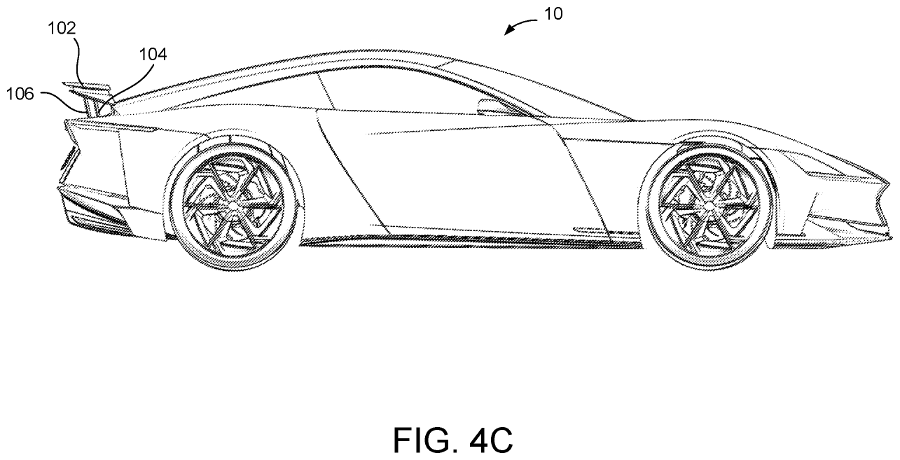

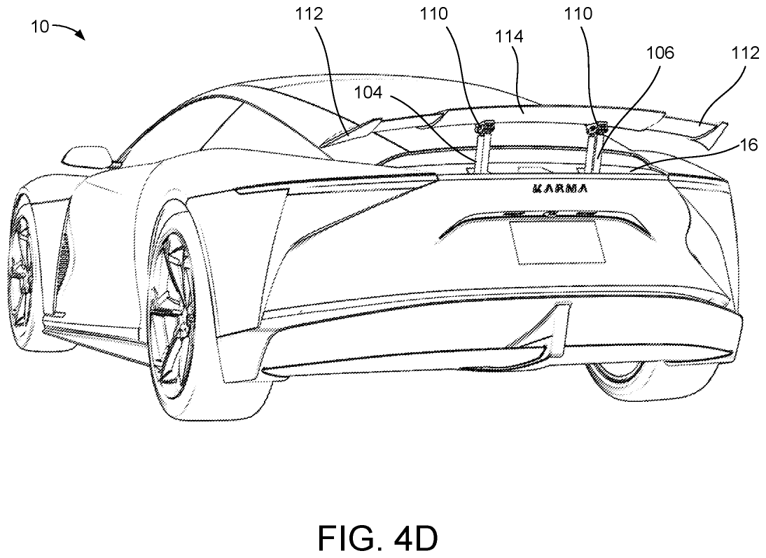

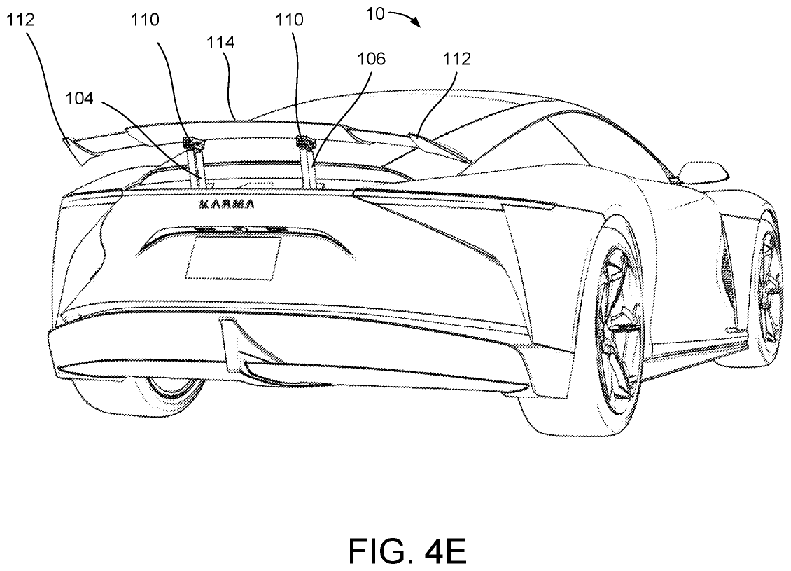

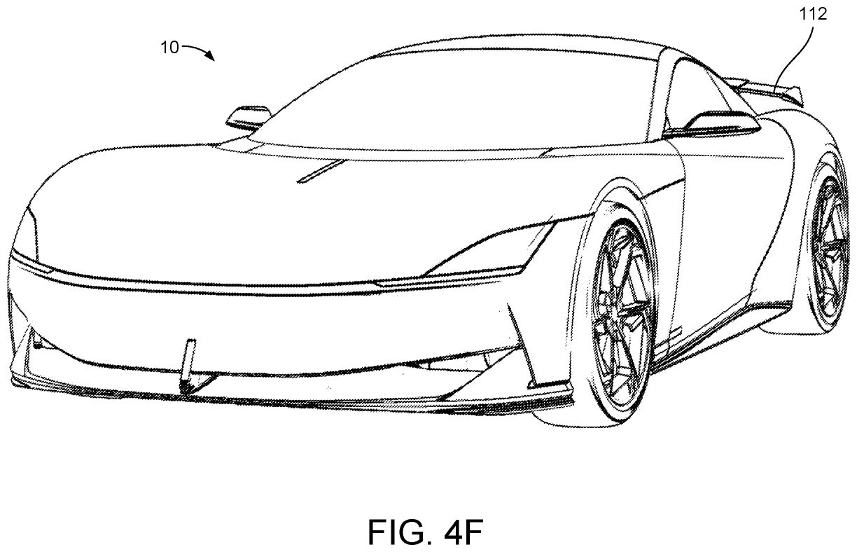

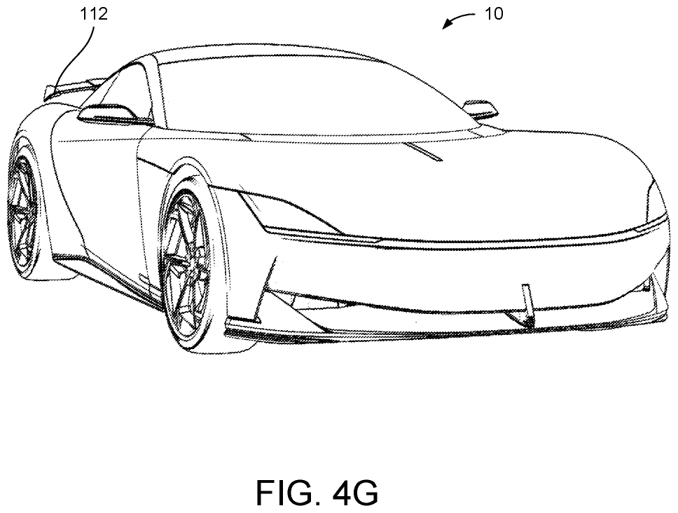

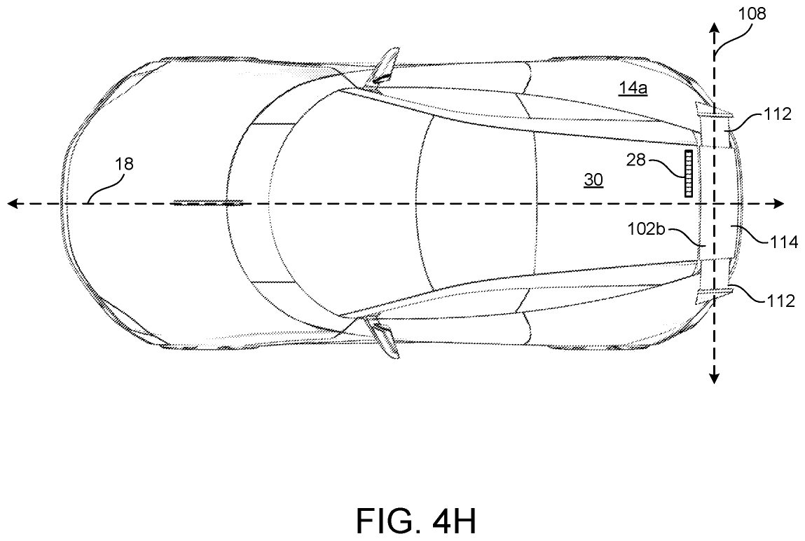

With the airfoil 102 in the first extended position (FIGS. 3A-3F), the airfoil 102 is further adjustable to a second driving or extended position (FIGS. 4A-4H). As shown in FIGS. 4A-4H, when the airfoil 102 is adjusted to the second extended position, outer lateral wing portions 112 of the airfoil 102 extend from opposing sides of a central portion 114 of the airfoil 102 along the longitudinal axis 108 of the airfoil 102. In the illustrated example, the airfoil 102 is a telescoping airfoil 102 such that the wing portions 112 are at least partially received within and along the central portion 114 and extend outward from the central portion 114 when the airfoil is adjusted to the second extended position. Thus, with the airfoil 102 in the second extended position, the airfoil 102 is extended at least partially away from the rear portion 14 of the vehicle 10 and the wing portions 112 are extended laterally from respective sides of the central portion 114 of the airfoil 102.

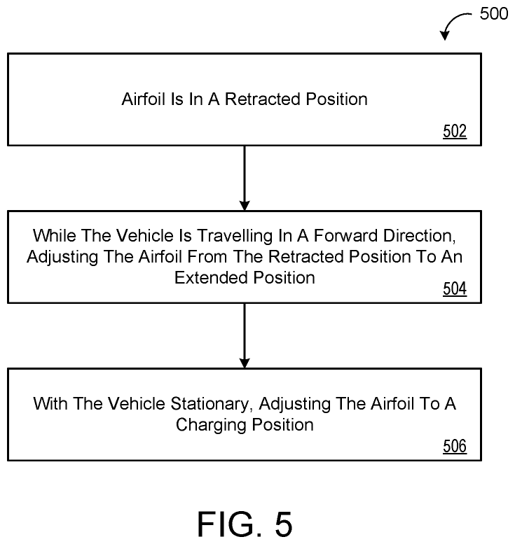

Referring to FIG. 1, the vehicle includes a control module or electronic control unit (ECU) 22 that includes data processing hardware 24 and memory hardware 26 in communication with the data processing hardware 24. The memory hardware 26 stores instructions that, when executed on the data processing hardware 24, cause the data processing hardware 24 to perform operations. For example, the memory hardware 26 stores instructions for controlling movement of the airfoil 102 between the retracted position, the first extended position, the second extended position, and the charging position, such as in accordance with the method 500 of FIG. 5 discussed further below.

Generally, the control module 22 controls movement of the airfoil 102 so that, while the vehicle 10 is travelling in a forward direction, the airfoil 102 is movable between the retracted position and the first extended position and/or the second extended position. When the vehicle 10 is stationary or parked and ready to receive the charging connector, the airfoil 102 is movable between the retracted position and the charging position so that the charge port 12 is accessible for charging the vehicle 10.

In other words, with the vehicle 10 travelling in a forward direction, the control module 22 adjusts the airfoil 102 to move between at least the retracted position and the first extended position, such as automatically adjusting the airfoil 102 based on a speed of the vehicle 10. For example, based on the vehicle 10 travelling at a speed that is greater satisfies a first threshold speed (e.g., the speed of the vehicle exceeds 55 miles per hour, 60 miles per hour, 80 miles per hour, and the like), the control module 22 adjusts the airfoil 102 to move from the retracted position to the first extended position. Based on the speed of the vehicle 10 subsequently reducing so that the speed now dissatisfies (e.g., is less than) the first threshold speed, the control module 22 adjusts the airfoil 102 to move back to the retracted position from the first extended position. The first threshold speed may be based on a speed where deployment of the airfoil 102 will have a significant enough impact on the lift and/or downforce at the vehicle 10. That is, the airfoil 102 may be extended at higher speeds to impart lift and/or downforce at the vehicle 10 and retracted at lower speeds, such as to reduce wind noise.

With the airfoil 102 in the first extended position, the control module 22 may further adjust the airfoil 102 to move to the second extended position, where the wing portions 112 extend laterally from the central portion 114 of the airfoil 102. For example, based on the vehicle 10 travelling at a speed that satisfies (e.g., is greater than) a second threshold speed greater than the first threshold speed (e.g., 60 miles per hour, 80 miles per hour, 100 miles per hour and the like), the control module 22 adjusts the airfoil 102 to move from the first extended position to the second extended position. Based on the speed of the vehicle 10 subsequently reducing to a value below the second threshold speed but still greater than the first threshold speed, the control module 22 adjusts the airfoil 102 to move from the second extended position to the first extended position. The second threshold speed may be based on a speed where further deployment of the airfoil 102 is needed to impart greater lift and/or downforce at the vehicle 10.

Moreover, with the airfoil 102 in the first extended position and/or the second extended position, the control module 22 may adjust a magnitude of extension and retraction by the forward pistons 104 and the rearward pistons 106 to adjust pitch or angle of the airfoil 102 relative to the longitudinal axis 18 of the vehicle 10. For example, the pitch of the airfoil 102 relative to the longitudinal axis 18 of the vehicle 10 may be adjusted based on the speed of the vehicle 10. As the speed of the vehicle 10 increases, the angle of the airfoil 102 relative to the longitudinal axis 18 of the vehicle 10 may be increased to increase the lift and/or downforce at the vehicle 10.

In some examples, the angle of the airfoil 102 may be adjusted based on operation of a brake system of the vehicle 10. That is, with the airfoil 102 in the first extended position and/or the second extended position, and when the brake system of the vehicle 10 is activated, the rearward pistons 106 may be extended to lift the rear portion of the airfoil 102 and tilt the airfoil 102 dramatically forward. For this reason, the drive mechanism coupled to the rearward pistons 106, such as a pneumatic drive mechanism, may be configured to rapidly extend and retract the rearward pistons 106 relative to the forward pistons 104.

Optionally, the airfoil 102 may be adjusted between the retracted position and the first extended position and/or second extended position based on a user input. For example, the control module may receive a user input indicating selection of an actuatable input which may be disposed at an interior cabin of the vehicle 10 (e.g., at a dashboard of the vehicle 10 or accessible through an infotainment system of the vehicle 10) so that the user or driver of the vehicle 10 can adjust the airfoil 102 between at least the retracted position the first extended position and the second extended position. Optionally, the driver of the vehicle 10 can adjust the pitch of the airfoil 102 in the first extended position or the second extended position via input at the interior cabin of the vehicle 10.

Further, the control module 22 may adjust the airfoil 102 to move between the retracted position and the first extended position and/or the second extended position based on a drive mode of the vehicle 10. For example, the airfoil 102 may move from the retracted position and into the first extended position based on selection of a sport mode of the vehicle 10 and from the first extended position to the second extended position based on selection of a track mode of the vehicle.

With the vehicle stationary and/or parked, the control module 22 can adjust the airfoil 102 to move from the retracted position and into the charging position so that the charge port 12 can receive the charging wand for charging the vehicle 10. For example, the control module 22 moves the airfoil 102 to the charging position, where the airfoil 102 is tilted or angled relative to the longitudinal axis 18 of the vehicle 10 in response to selection of a charging mode of the vehicle 10. The angle of the airfoil 102 relative to the longitudinal axis 18 of the vehicle 10 is greater when the airfoil 102 is in the charging position than when the airfoil 102 is in the first extended position and/or the second extended position.

The control module 22 may adjust the airfoil 102 to move into the charging position in response to a user input. For example, the user input may indicate selection of the actuatable input 28 within the interior cabin of the vehicle 10 (e.g., at or beneath the dashboard or accessible through the infotainment system of the vehicle 10) when the vehicle 10 is parked to ready the vehicle 10 for charging. The airfoil 102 may further be adjustable to the charging position based on a signal received from a key fob associated with the vehicle 10.

Optionally, the actuatable input may be accessible exterior the vehicle 10 and disposed at or near the rear portion 14 of the vehicle 10 so that the user can adjust the airfoil 102 to the charging position when outside the vehicle 10. The actuatable input may correspond to a physical button/switch or may include a touch sensor, capactive sensor, tactile button, or optical sensor such that the user can provide the user input via touch or gesture proximate to the location of the actuatable input.

In some examples, the actuatable input 28, such as a capacitive sensor, is disposed at an exterior portion of the vehicle 10, such as at an outer surface of a body panel of the vehicle 10, the upper surface 102b of the airfoil 102, or the rear window 30 of the vehicle 10 for sensing manual or touch inputs from the user at the exterior input 28. The user may provide any suitable manual input at the exterior input 28, such as a touch or a sliding motion, and the control module 22 may move the airfoil 102 between the retracted position and the charging position based on the user input. For example, a first icon representative of the charging position may be etched or otherwise disposed at the rear window 30 at a first end of the sliding actuatable input 28 so that, responsive to the user sliding their finger along the exterior input 28 toward the first icon, the airfoil 102 is moved to the charging position. A second icon representative of a second operation (e.g., opening the trunk or hatch of the vehicle 10, operating the lights of the vehicle 10 and the like) may be etched or otherwise disposed at the rear window 30 at a second end of the sliding input 28 so that, responsive to the user sliding their finger along the exterior input 28 toward the second icon, the second operation is performed. The exterior input 28 may provide haptic feedback to the user.

Thus, the retractable airfoil system 100 provides an airfoil 102 that, in the retracted position, extends over and along the charge port 12 of the vehicle 10 to conceal and/or protect the charge port 12. An outer surface 102b of the airfoil 102 is generally flush with an outer surface 14a of the rear portion 14 of the vehicle 10 surrounding the airfoil 102 and the charge port 12 when the airfoil 102 is in the retracted position. The airfoil 102 is movable to a charging position, where the airfoil 102 is extended at least partially away from the rear portion 14 of the vehicle 10 and the charge port 12 to allow access the charge port 12 for charging the vehicle 10. The airfoil 102 may be tilted or canted or pitched relative to a longitudinal axis 18 of the vehicle 10 in the charging position. The airfoil 102 is moved to the charging position based on a user input indicating selection of the actuatable input 28 accessible exterior the vehicle 10, such as disposed along the rear window 30. The airfoil 102 is further movable between the retracted position and at least a first extended position when the vehicle 10 is travelling in a forward direction, such as based on the vehicle 10 travelling at a speed greater than a first threshold speed or based on a user input. When in the extended position, the airfoil 102 deflects airflow moving across the airfoil 102 to impart lift and/or downforce at the vehicle 10. The airfoil 102 further includes telescoping lateral wing portions 112 that telescope or extend outward from opposing ends of a central portion 114 of the airfoil 102 (e.g., along a longitudinal axis 108 of the airfoil 102) to adjust the airfoil 102 to a second extended position. For example, the airfoil 102 is extended to the second extended position based on the vehicle 10 travelling at a speed greater than a second threshold speed or based on an additional user input.

FIG. 5 provides a flowchart of an exemplary arrangement of operations for a method 500 of controlling operation of the airfoil 102. The data processing hardware 24 of the control module 22 may execute instructions stored on memory storage 26 to cause the data processing hardware 24 to perform the operations for the method 500. At operation 502, the method 500 includes positioning the airfoil 102 in the retracted position. At operation 504, the method 500 includes, while the vehicle 10 is travelling in a forward direction, adjusting the airfoil 102 to move from the retracted position to a first extended position. For example, the airfoil 102 may be adjusted to move into the first extended position based on the vehicle 10 travelling at a speed that satisfies (e.g., is greater than) a first threshold speed or based on a user input. At operation 504, the method 500 includes, with the vehicle 10 stationary or parked, adjusting the airfoil 102 to move into the charging position.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed on data processing hardware causes the data processing hardware to perform operations comprising:
while a vehicle travels in a forward direction, adjusting an airfoil of the vehicle to move between:
a retracted position, where at least a portion of the airfoil is recessed into a rear portion of the vehicle; and
a first extended position, where the airfoil is extended away from the rear portion of the vehicle.

2. The method of claim 1, wherein the operations further comprise, while the vehicle travels in the forward direction and the airfoil is in the first extended position, adjusting the airfoil to move between the first extended position and a second extended position, wherein, when the airfoil is in the second extended position, at least a portion of the airfoil is extended away from the rear portion of the vehicle and wing portions of the airfoil are extended laterally from respective sides of a central portion of the airfoil.

3. The method of claim 1, wherein the operations further comprise adjusting a pitch of the airfoil when the airfoil is in the first extended position.

4. The method of claim 3, wherein adjusting the pitch of the airfoil is based on a speed of the vehicle or operation of a brake system of the vehicle.

5. The method of claim 1, wherein the operations further comprise, when the airfoil is in the retracted position:
receiving a speed of the vehicle while the vehicle travels in the forward direction;
determining the speed of the vehicle satisfies a threshold speed; and
based on determining the speed of the vehicle satisfies the threshold speed, adjusting the airfoil to move from the retracted position to the first extended position.

6. The method of claim 5, wherein the operations further comprise, after adjusting the airfoil to move from the retracted position to the first extended position:
determining the speed of the vehicle dissatisfies the threshold speed; and
based on determining that the speed of the vehicle dissatisfies the threshold speed, adjusting the airfoil to move from the first extended position to the retracted position.

7. The method of claim 1, wherein the operations further comprise:
receiving a user input,
wherein adjusting the airfoil to move between the retracted position and the first extended position is based on the user input.

8. The method of claim 1, wherein the operations further comprise, while the vehicle is stationary and the airfoil is in the retracted position:
adjusting the airfoil of the vehicle to move from the retracted position into a charging position,
wherein, when the airfoil is in the charging position, the airfoil is:
extended away from the rear portion of the vehicle; and
pitched upward to allow access to a charge port of the vehicle, the charge port disposed in a recess at the rear portion of the vehicle.

9. The method of claim 8, wherein, when the airfoil is in the retracted position, the airfoil extends over and along the recess to conceal the charge port from an exterior of the vehicle.

10. The method of claim 8, wherein the operations further comprise, while the vehicle is stationary and the airfoil is in the retracted position:
receiving a user input indicating selection of an actuatable input, the actuatable input accessible exterior the vehicle and disposed at or near the rear portion of the vehicle,
wherein adjusting the airfoil of the vehicle to move into the charging position is based on the received user input indicating selection of the actuatable input.

11. The method of claim 10, wherein the actuatable input is disposed at an exterior side of a rear window of the vehicle, at a body panel of the vehicle at or near the rear portion of the vehicle, or at an exterior surface of the airfoil.

12. A vehicle comprising:
data processing hardware; and
memory hardware in communication with the data processing hardware, the memory hardware storing instructions executed on the data processing hardware that cause the data processing hardware to perform operations comprising:
while the vehicle travels in a forward direction, adjusting an airfoil of the vehicle to move between:
a retracted position, where at least a portion of the airfoil is recessed into a rear portion of the vehicle; and
a first extended position, where the airfoil is extended away from the rear portion of the vehicle.

13. The vehicle of claim 12, wherein the operations further comprise, while the vehicle travels in the forward direction and the airfoil is in the first extended position, adjusting the airfoil to move between the first extended position and a second extended position, wherein, when the airfoil is in the second extended position, at least a portion of the airfoil is extended away from the rear portion of the vehicle and wing portions of the airfoil are extended laterally from respective sides of a central portion of the airfoil.

14. The vehicle of claim 12, wherein the operations further comprise adjusting a pitch of the airfoil when the airfoil is in the first extended position.

15. The vehicle of claim 14, wherein adjusting the pitch of the airfoil is based on a speed of the vehicle or operation of a brake system of the vehicle.

16. The vehicle of claim 12, wherein the operations further comprise, when the airfoil is in the retracted position:
receiving a speed of the vehicle while the vehicle travels in the forward direction;
determining the speed of the vehicle satisfies a threshold speed; and
based on determining the speed of the vehicle satisfies the threshold speed, adjusting the airfoil to move from the retracted position to the first extended position.

17. The vehicle of claim 16, wherein the operations further comprise, after adjusting the airfoil to move from the retracted position to the first extended position:
determining the speed of the vehicle dissatisfies the threshold speed; and
based on determining that the speed of the vehicle dissatisfies the threshold speed, adjusting the airfoil to move from the first extended position to the retracted position.

18. The vehicle of claim 12, wherein the operations further comprise:
receiving a user input,
wherein adjusting the airfoil to move between the retracted position and the first extended position is based on the user input.

19. The vehicle of claim 12, wherein the operations further comprise, while the vehicle is stationary and the airfoil is in the retracted position:
adjusting the airfoil of the vehicle to move into a charging position from the retracted position,
wherein, when the airfoil is in the charging position, the airfoil is:
extended away from the rear portion of the vehicle; and
pitched upward to allow access to a charge port of the vehicle, the charge port disposed in a recess at the rear portion of the vehicle.

20. The vehicle of claim 19, wherein, when the airfoil is in the retracted position, the airfoil extends over and along the recess to conceal the charge port from an exterior of the vehicle.

21. The vehicle of claim 19, wherein the operations further comprise, while the vehicle is stationary and the airfoil is in the retracted position:
receiving a user input indicating selection of an actuatable input, the actuatable input accessible exterior the vehicle and disposed at or near the rear portion of the vehicle,
wherein adjusting the airfoil of the vehicle to move into the charging position is based on the received user input indicating selection of the actuatable input.

22. The vehicle of claim 21, wherein the actuatable input is disposed at an exterior side of a rear window of the vehicle, at a body panel of the vehicle at or near the rear portion of the vehicle, or at an exterior surface of the airfoil.
